(19) United States
(12) Patent Application Publication
(10) Pub. No.: US 2025/0142603 A1
(43) Pub. Date: May 1, 2025

(54) METHOD, DEVICE AND COMPUTER READABLE MEDIUM FOR COMMUNICATIONS

(71) Applicant: NEC CORPORATION, Tokyo (JP)

(72) Inventors: Gang WANG, Beijing (CN); Zhaobang MIAO, Beijing (CN)

(73) Assignee: NEC CORPORATION, Tokyo (JP)

(21) Appl. No.: 18/833,761

(22) PCT Filed: Jan. 27, 2022
(86) PCT No.: PCT/CN2022/074336

§ 371 Date: Jul. 26, 2024

(51) Int. Cl. H04W 72/40; H04W 72/0453; H04W 72/0457

(52) U.S. Cl. CPC H04W 72/40; H04W 72/0453; H04W 72/0457

(57) ABSTRACT

Embodiments of the present disclosure relate to method, device and computer readable media for communications. The method comprises determining, at a terminal device, an allocation of sub-channel resources based on sidelink resource configuration information, each of the sub-channel resources comprising a first number of interlaces in frequency domain. The method also comprises transmitting or receiving a sidelink signal on at least one of the sub-channel resources.

### TECHNICAL FIELD

Embodiments of the present disclosure generally relate to the field of telecommunication, and in particular, to a method, device and computer readable media for sidelink communication.

### BACKGROUND

Sidelink on unlicensed spectrum or band (SL-U) is to be studied in the 3rd Generation Partnership Project (3GPP). The scheme of SL-U should base on New Radio (NR) sidelink and NR on unlicensed spectrum (NR-U). Interlace of resource blocks (IRB) is used as a frequency resource unit for NR-U uplink. Sidelink sub-channel is used as a frequency resource unit for Physical Sidelink Shared Channel (PSSCH) of NR sidelink.

### SUMMARY

In general, example embodiments of the present disclosure provide methods, devices and computer readable media for communications.

In a first aspect, there is provided a method for communications. The method comprises: determining, at a terminal device, an allocation of sub-channel resources based on sidelink resource configuration information, each of the sub-channel resources comprising a first number of interlaces in frequency domain; and transmitting or receiving a sidelink signal on at least one of the sub-channel resources.

In a second aspect, there is provided a terminal device. The terminal device comprises a processor and a memory storing instructions. The memory and the instructions are configured, with the processor, to cause the terminal device to perform the method according to the first aspect.

In a third aspect, there is provided a computer readable medium having instructions stored thereon. The instructions, when executed on at least one processor of a device, cause the device to perform the method according to the first aspect.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1 illustrates an example communication network in which implementations of the present disclosure can be implemented;

FIG. 2 illustrates an example of automatic gain control (AGC) symbol and guard period (GP) symbol in accordance with some embodiments of the present disclosure;

FIG. 3 illustrates an example of a sub-channel in a frequency resource scheme for sidelink on licensed spectrum in accordance with some embodiments of the present disclosure;

FIG. 4 illustrates an example of an RB set in an NR-U IRB scheme in accordance with some embodiments of the present disclosure;

FIG. 5 illustrates an example of IRBs in an NR-U IRB scheme in accordance with some embodiments of the present disclosure;

FIG. 6 illustrates a flowchart of an example method in accordance with some embodiments of the present disclosure;

FIG. 7A to 7C illustrate an example of sub-channel resources in accordance with some embodiments of the present disclosure, respectively;

FIG. 8A to 8E illustrate an example of sub-channel resources in accordance with some embodiments of the present disclosure, respectively;

FIG. 9A to 9C illustrate an example of sub-channel resources in accordance with some embodiments of the present disclosure, respectively; and

FIG. 10 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term ‘terminal device’ refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Small Data Transmission (SDT), mobility, Multicast and Broadcast Services (MBS), positioning, dynamic/flexible duplex in commercial networks, reduced capability (RedCap), Space borne vehicles or Air borne vehicles in Non-terrestrial networks (NTN) including Satellites and High Altitude Platforms (HAPs) encompassing Unmanned Aircraft Systems (UAS), extended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also incorporate one or multiple Subscriber Identity Module (SIM) as known as Multi-SIM. The term “terminal device” can be used interchangeably with a UE, a mobile station, a subscriber station, a mobile terminal, a user terminal or a wireless device.

The term “network device” refers to a device which is capable of providing or hosting a cell or coverage where terminal devices can communicate. Examples of a network device include, but not limited to, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), Network-controlled Repeaters, and the like.

The terminal device or the network device may have Artificial intelligence (AI) or Machine learning capability. It generally includes a model which has been trained from numerous collected data for a specific function, and can be used to predict some information.

The terminal or the network device may work on several frequency ranges, e.g. FR1 (410 MHz-7125 MHz), FR2 (24.25 GHz to 71 GHz), frequency band larger than 100 GHz as well as Tera Hertz (THz). It can further work on licensed/unlicensed/shared spectrum. The terminal device may have more than one connection with the network devices under Multi-Radio Dual Connectivity (MR-DC) application scenario. The terminal device or the network device can work on full duplex, flexible duplex and cross division duplex modes.

The network device may have the function of network energy saving, Self-Organising Networks (SON)/Minimization of Drive Tests (MDT). The terminal may have the function of power saving.

The embodiments of the present disclosure may be performed in test equipment, e.g. signal generator, signal analyzer, spectrum analyzer, network analyzer, test terminal device, test network device, channel emulator

The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘some embodiments’ and ‘an embodiment’ are to be read as ‘at least some embodiments.’ The term ‘another embodiment’ is to be read as ‘at least one other embodiment.’ The terms ‘first,’ ‘second,’ and the like may refer to different or same objects. Other definitions, explicit and implicit, may be included below.

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

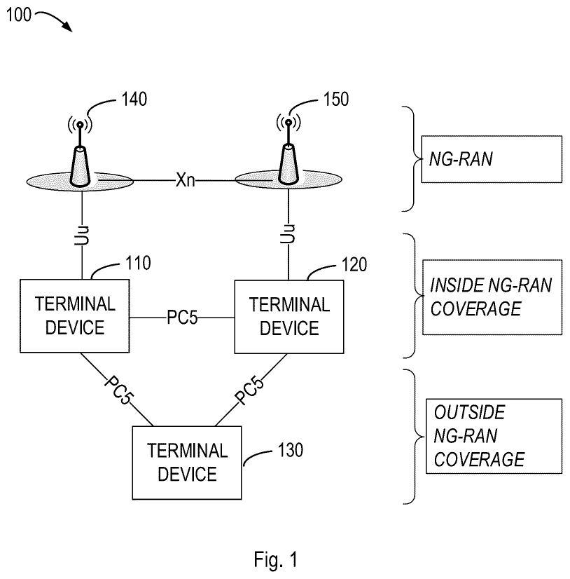

FIG. 1 illustrates a schematic diagram of an example communication network 100 in which embodiments of the present disclosure can be implemented. As shown in FIG. 1, the communication network 100 may include a terminal device 110, a terminal device 120, a terminal device 130, network devices 140 and 150. The network devices 140 and 150 may communicate with the terminal device 110, the terminal device 120 and the terminal device 130 via respective wireless communication channels.

In some embodiments, the network device 140 may be a gNB in NR, and the network device 150 may be an eNB in Long Term Evolution (LTE) system.

It is to be understood that the number of devices in FIG. 1 is given for the purpose of illustration without suggesting any limitations to the present disclosure. The communication network 100 may include any suitable number of network devices and/or terminal devices adapted for implementing implementations of the present disclosure.

The communications in the communication network 100 may conform to any suitable standards including, but not limited to, Global System for Mobile Communications (GSM), LTE, LTE-Evolution, LTE-Advanced (LTE-A), Wideband Code Division Multiple Access (WCDMA), Code Division Multiple Access (CDMA), GSM EDGE Radio Access Network (GERAN), Machine Type Communication (MTC) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols.

In some embodiments, the communications in the communication network 100 may comprise sidelink communication. Sidelink communication is a wireless radio communication directly between two or more terminal devices, such as two or more terminal devices among the terminal device 110, the terminal device 120 and the terminal device 130. In this type of communication, the two or more terminal devices that are geographically proximate to each other can directly communicate without going through the network device 140 or 150 or through a core network. Data transmission in sidelink communication is thus different from typical cellular network communications, in which a terminal device transmits data to the network device 140 or 150 (i.e., uplink transmissions) or receives data from the network device 140 or 150 (i.e., downlink transmissions). In sidelink communication, data is transmitted directly from a source terminal device (such as the terminal device 110) to a target terminal device (such as the terminal device 120) through the Unified Air Interface, e.g., PC5 interface, (i.e., sidelink transmissions), as shown in FIG. 1.

Sidelink communication can provide several advantages, including reducing data transmission load on a core network, system resource consumption, transmission power consumption, and network operation costs, saving wireless spectrum resources, and increasing spectrum efficiency of a cellular wireless communication system.

In a sidelink communication system, the sidelink resource is used to transmit information between terminal devices. According to application scenarios, service types, etc., a sidelink communication manner includes but is not limited to device to device (D2D) communication, Vehicle-to-Everything (V2X) communication, etc.

V2X communication enables vehicles to communicate with other vehicles (i.e. Vehicle-to-Vehicle (V2V) communication), with infrastructure (i.e. Vehicle-to-Infrastructure (V2I), with wireless networks (i.e. Vehicle-to-Network (V2N) communication), with pedestrians (i.e. Vehicle-to-Pedestrian (V2P) communication), and even with the owner's home (i.e. Vehicle-to-Home (V2H)). Examples of infrastructure include roadside units such as traffic lights, toll gates and the like. V2X communication can be used in a wide range of scenarios, including in accident prevention and safety, convenience, traffic efficiency and clean driving, and ultimately in relation to autonomous or self-driving vehicles.

For sidelink communications, a terminal device uses resources in sidelink resource pools to transmit or receive signals. The sidelink resource pools include resources in time domain and frequency domain, which are dedicated resources of the sidelink communication, or shared by the sidelink communication and a cellular link.

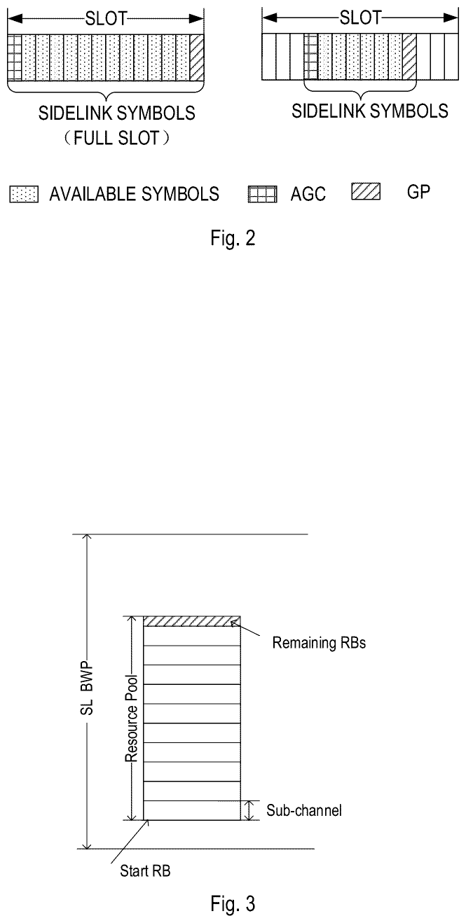

In a sidelink resource pool which may contain multiple slots and resource blocks (RBs), and all or part of the symbols in a slot can be used for sidelink transmission. Within a resource pool, among all the symbols configured for sidelink in each slot, the first symbol (i.e., the start symbol) is used as the automatic gain control (AGC) symbol, and the last symbol used as a guard period (GP) symbol. AGC symbols and GP symbols can be considered as fixed overheads in sidelink resource. In the description of the following embodiments, AGC symbols and GP symbols are included in the sidelink symbols which are indicated by the sidelink channel resource configuration, and AGC symbols carry redundancy sidelink information while GP symbols are not used for carrying sidelink information, as shown in FIG. 2.

The terminal device 110, the terminal device 120 and the terminal device 130 may use sidelink channels to transmit sidelink signaling or information. The sidelink channels include at least one of the following: a Physical Sidelink Control Channel (PSCCH) resource which is used for carrying sidelink control information (SCI), a PSSCH resource which is used for carrying sidelink data service information, a physical sidelink feedback channel (PSFCH) resource which is used for carrying sidelink ACK/NACK feedback information, a physical sidelink broadcast channel (PSBCH) resource which is used for carrying sidelink broadcast information, and a physical sidelink discovery channel (PSDCH) resource which is used for carrying a sidelink discovery signal.

As mentioned above, sidelink sub-channel is used as a frequency resource unit for PSSCH of NR sidelink. FIG. 3 illustrates an example of a sub-channel in a frequency resource scheme for sidelink on licensed spectrum in accordance with some embodiments of the present disclosure. As shown in FIG. 3, a resource pool may be configured within a SL Bandwidth Part A resource (BWP). pool configuration may comprise sl-StartRB-Subchannel and sl-RB-Number. The sl-StartRB-Subchannel may indicate the lowest Resource Block (RB) of the resource pool. The lowest RB is also referred to as a start RB. The sl-RB-Number may indicate the total number of RBs of the resource pool.

RBs in the resource pool may be divided into consecutive sub-channels. Sub-channel is a frequency resource unit of PSSCH. Each sub-channel contains consecutive RBs. A terminal device may use one or more consecutive sub-channels as a PSSCH resource to transmit sidelink data. A sub-channel configuration of the resource pool may comprise sl-SubchannelSize which indicates the number of RBs contained in one sub-channel. The SubchannelSize may be equal to 10, 12, 15, 20, 25, 50, 75 or 100.

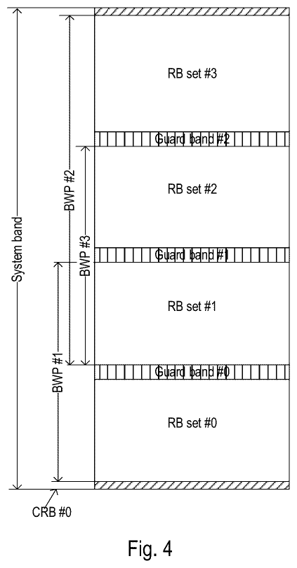

As mentioned above, IRB is used as a frequency resource unit for NR-U uplink. FIG. 4 illustrates an example of an RB set in an NR-U IRB scheme in accordance with some embodiments of the present disclosure. As shown in FIG. 4, BWPs #1, #2 and #3 are defined on a system band. The BWP #1 comprises RB sets #0 and #1. The BWP #2 comprises RB sets #1, #2 and #3. The BWP #3 comprises RB sets #1 and #2.

Each of the RB sets may be defined as 20 MHz. For Subcarrier Spacing (SCS) of 15 KHz, each of the RB sets may comprises 100 to 110 RBs. For SCS of 30 KHz, each of the RB sets may comprises 50 to 55 RBs. There may be a guard band between two adjacent RB sets.

It will be understood that although it is shown in FIG. 4 that each of BWPs comprises a plurality of RB sets, in some embodiments, one or more of the BWPs may comprise a single RB set.

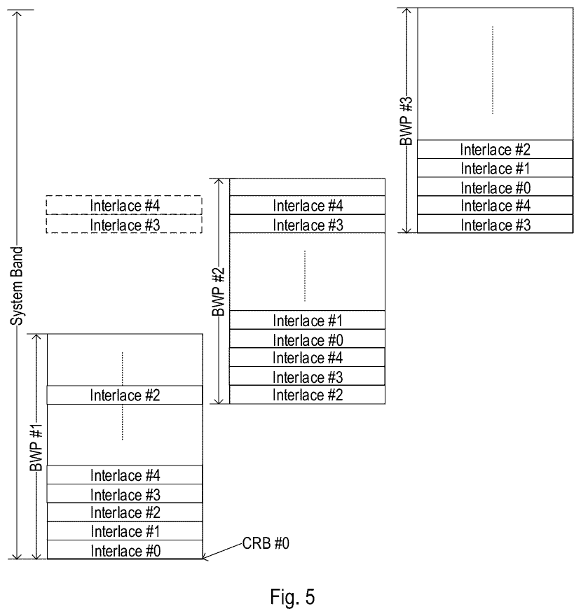

FIG. 5 illustrates an example of IRBs in an NR-U IRB scheme in accordance with some embodiments of the present disclosure. In the present disclosure, terms “IRB” and “interlace” may be used interchangeably. As shown in FIG. 5, IRBs are defined on a system band. In other words, IRBs are defined within a carrier. IRB with an index 0 starts from a Common Resource Block (CRB) with an index 0. For SCS of 15 KHz, 10 IRBs may be defined within a carrier. For SCS of 30 KHz, 5 IRBs may be defined within a carrier.

Hereinafter, for brevity, IRB or interlace with an index X is also referred to as IRB #X or interlace #X, and RB or CRB with an index Y is also referred to as RB #Y or CRB #Y. Similarly, RB set or SL BWP with an index Z is also referred to as RB set #Z or SL BWP #Z. Each of X, Y and Z is a non-negative integer.

Because the scheme of SL-U should base on NR sidelink and NR-U, the mapping relationship between sub-channel and IRB should be defined.

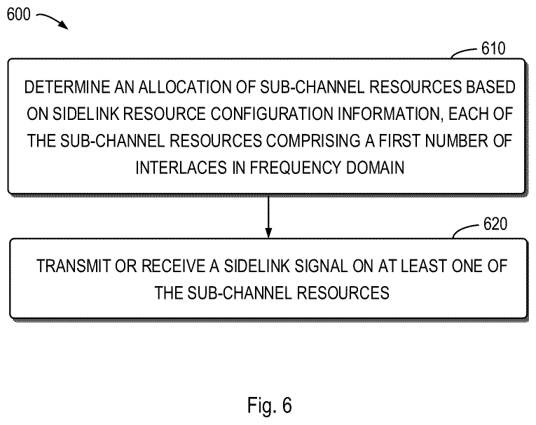

FIG. 6 illustrates a flowchart of an example method 600 in accordance with some embodiments of the present disclosure. In some embodiments, the method 600 can be implemented at a terminal device, such as one of the terminal device 110, the terminal device 120 and the terminal device 130 as shown in FIG. 1. For the purpose of discussion, the method 600 will be described with reference to FIG. 1 as performed by the terminal device 110 without loss of generality.

At block 610, the terminal device 110 determines an allocation of sub-channel resources based on sidelink resource configuration information. Each of the sub-channel resources comprises a first number of interlaces in frequency domain. Hereinafter, the first number may be represented by k.

At block 620, the terminal device 110 transmits or receives a sidelink signal on at least one of the sub-channel resources.

It should be understood that it is assumed that the definition of IRB in the NR-U IRB scheme is used in embodiments of the present disclosure.

In some embodiments, the sidelink resource configuration information may comprise at least one of the following:
an interlace enablement indication which indicates using interlace as frequency domain resource unit for sidelink transmission,
a sub-channel configuration,
a sidelink carrier configuration,
a sidelink BWP configuration, or
a sidelink resource pool configuration.

In some embodiments, the terminal device 110 may obtain the sidelink resource configuration information from at least one of following: pre-definition, configuration, or pre-configuration.

In some embodiments, the sub-channel configuration may be for at least one of the following: a sidelink resource pool, a sidelink BWP, a sidelink carrier, or an RB set.

In some embodiments, the first number is equal to one, and the sub-channel resources may comprise a first sub-channel resource, the first sub-channel resource comprising RBs in a first interlace. In other words, one sub-channel resource may be mapped to one IRB.

In some embodiments, one sub-channel resource contains RB #[n, n+M, n+2M, n+3M, . . . ], where M represents the number of IRBs. For SCS of 15 KHz, M=10. For SCS of 30 KHz, M=5. RB #n represents the lowest RB of the sub-channel resource.

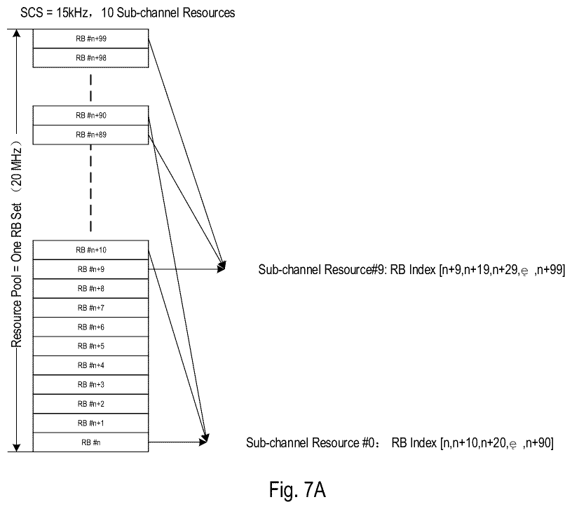

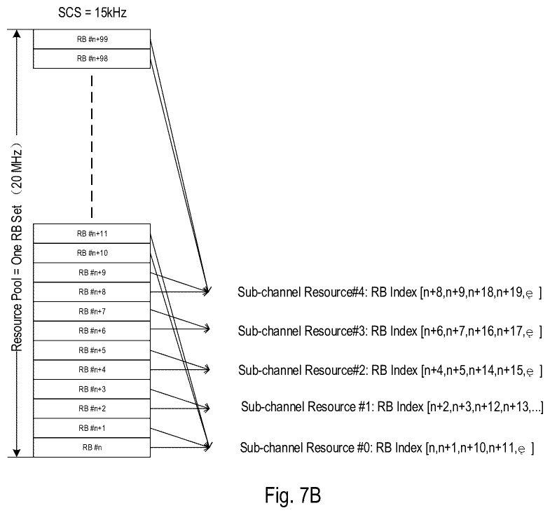

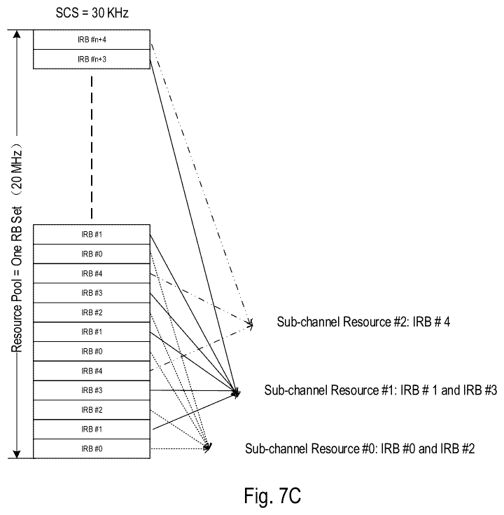

FIG. 7A illustrates an example of sub-channel resources in accordance with some embodiments of the present disclosure. In the example of FIG. 7A, SCS is 15 KHz, the number of IRB is M=10, and the first number k=1, i.e., the number of sub-channel resources is 10, and there is a one-to-one mapping relationship between sub-channels and IRBs. For example, within a resource pool (or an RB set), sub-channel resource #0 contains RB #[n, n+10, n+20, . . . , n+90], . . . , sub-channel resource #9 contains RB #[n+9, n+19, n+29, . . . , n+99], where RB #n represents the lowest RB of the resource pool (or the RB set).

In some embodiments, the first number is equal to or larger than one. In other words, one sub-channel resource may be mapped to k IRBs, k>=1.

In some embodiments, the sub-channel configuration comprises a size of each of the sub-channel resources. In some embodiments, the size of each of the sub-channel resources may indicate the first number, wherein the first number is a positive integer.

For example, the terminal device 110 may receive, from the network device 140, the sub-channel configuration through a system information block (SIB) message, the SIB message may comprise at least one of the following:
SL-U-ResourcePool
   useInterlacePSCCH-PSSCH NUMERATED {enabled}
   sl-U-SubchannelSize ENUMERATED {n1, n2, n3, n4, n5, n6, n7, n8, n9,n10}
      where SL-U-ResourcePool represents the sidelink resource configuration for a resource pool, useInterlacePSCH-PSSCH represents an interlace enablement indication, and when it is presented, it indicates using interlace as frequency domain resource unit for PSCCH/PSSCH for SL-U communication. Sl-U-SubchannelSize indicates the granularity in frequency domain of a sub-channel resource for sidelink transmission in the unit of IRB. In other words, sl-U-SubchannelSize indicates the first number (k). For example, n1 represents a sub-channel resource is mapped to one IRB, n2 represents a sub-channel resource is mapped to two IRBs, and so on. In this way, such embodiments may provide more flexibility for sub-channel configuration based on IRB structure.

FIG. 7B illustrates an example of sub-channel resources in accordance with some

embodiments of the present disclosure. In the example of FIG. 7B, k=2 and k is configured per resource pool. One sub-channel resource contains RBs #[n, n+1, n+M, n+M+1, n+2M, n+2M+1, . . . ], where RB #n represents the lowest RB of the resource pool, M represents the number of interlaces, M=10 for SCS=15 KHz. For example, sub-channel resource #0 contains RBs #[n, n+1, n+10, n+11 . . . ], sub-channel resource #1 contains RBs #[n+2, n+3, n+12, n+13 . . . ], . . . , sub-channel resource #4 contains RBs #[n+8, n+9, n+18, n+19 . . . ].

In some embodiments, the size of each of the sub-channel resources may indicate a second number of RBs contained in each of the sub-channel resources. For example, the terminal device 110 may receive, from the network device 140, the sub-channel configuration through an SIB message, the SIB message may comprise at least one of the following:
SL-U-ResourcePool
   useInterlacePSCH-PSSCH ENUMERATED {enabled}
   sl-U-SubchannelSize ENUMERATED {n10, n20, n30, n40, n50, n60, n70, n80, n90, n100}
      where SL-U-ResourcePool represents the sidelink resource configuration for an SL BWP, useInterlacePSCH-PSSCH represents the interlace enablement indication, and when it is presented, it indicates using interlace as frequency domain resource unit for PSCCH/PSSCH, sl-U-SubchannelSize indicates the granularity in frequency domain of a sub-channel resource for PSSCH in the unit of RB. In other words, sl-U-SubchannelSize indicates the second number of RBs contained in each of the sub-channel resources. For example, n10 represents that 10 RBs are contained in each of the sub-channel resources, n20 represents that 20 RBs are contained in each of the sub-channel resources, and so on. In this way, such embodiments may provide more flexibility for sub-channel configuration based on IRB structure.

In such embodiments, the terminal device 110 may determine the first number based on the second number and a third number. The third number is the number of RBs in an interlace within one of the following: an RB set, a sidelink resource pool, or a sidelink BWP.

In such embodiments, the terminal device 110 may determine the first number as the second number divided by the third number. For example, k=sl-U-SubchannelSize/M0, where sl-U-SubchannelSize represents the second number, and M0 represents the third number.

Alternatively, the terminal device 110 may determine the first number by rounding down the second number divided by the third number. For example, k=[sl-U-SubchannelSize/M0].

Alternatively, the terminal device 110 may determine the first number by rounding up the second number divided by the third number. For example, k=[sl-U-SubchannelSize/M0].

In embodiments where the first number is larger than one, each of the sub-channel resources may comprise RBs in the first number of interlaces with consecutive interlace indexes. In other words, one sub-channel resource may be mapped to consecutive k IRBs, as shown in FIG. 7B.

Alternatively, in embodiments where the first number is larger than one, each of the sub-channel resources may comprise RBs in the first number of interlaces with non-consecutive interlace indexes. In other words, one sub-channel resource may be mapped to non-consecutive k IRBs. In this way, discrete RB allocation for a sub-channel is provided.

In some embodiments, consecutive or non-consecutive mapping between a sub-channel resource and IRBs may be predefined in SL-U system. Alternatively, the consecutive or non-consecutive mapping may be configured or pre-configured by high layer.

FIG. 7C illustrates an example of sub-channel resources in accordance with some embodiments of the present disclosure. In the example of FIG. 7C, k=2, and one sub-channel resource may be mapped to non-consecutive two IRBs. Sub-channel resource #0 is mapped to IRB #0 and IRB #2. Sub-channel resource #1 is mapped to IRB #1 and IRB #3. Sub-channel resource #2 is mapped to IRB #4. When the number of IRB is not a multiple of the first number, at least one of sub-channel may contain a number of IRBs which is less than the first number, as the sub-channel #2 in this example.

In embodiments where the first number is equal to one, i.e., one-to-one mapping relationship between sub-channels and IRBs, an index of a sub-channel may be identical to an index of a respective IRB. In embodiments where the first sub-channel resource comprises RBs in the first interlace, an index of the first sub-channel resource may be identical to an index of the first interlace. In such embodiments, as IRB index is numbered per carrier, an index of the lowest sub-channel resource may be not zero within a resource pool.

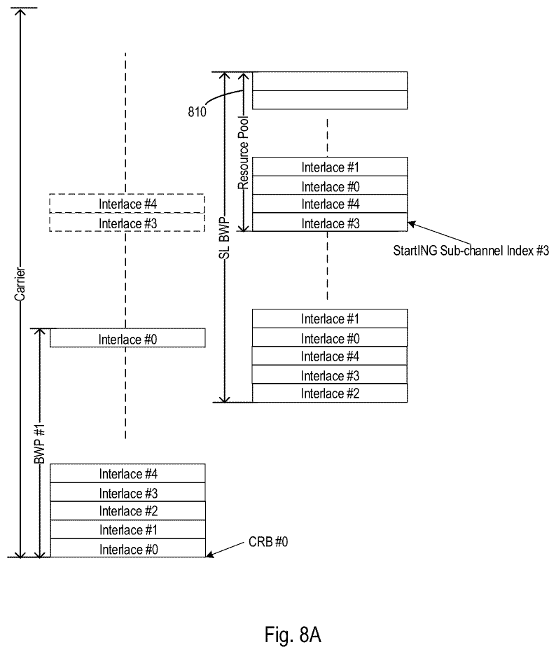

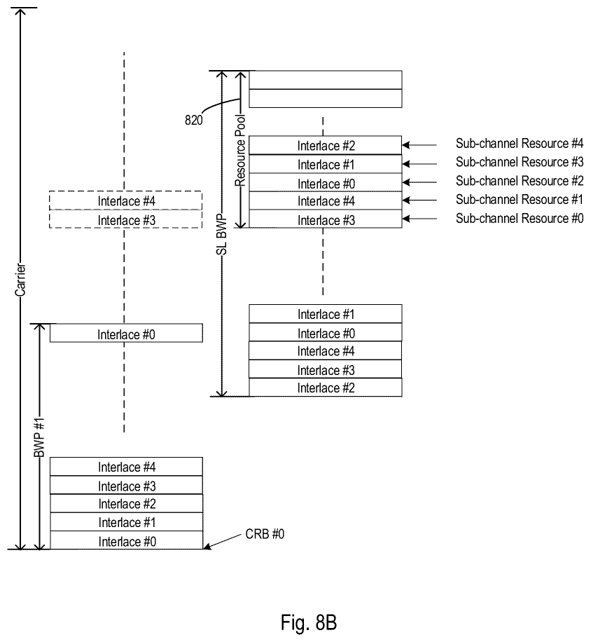

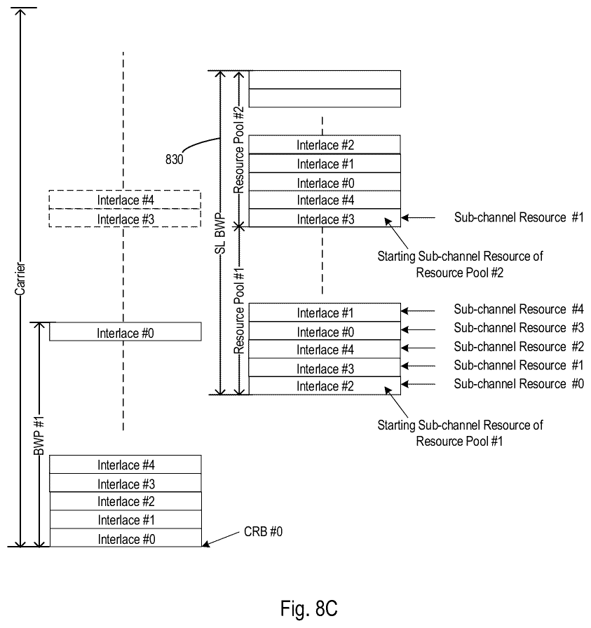

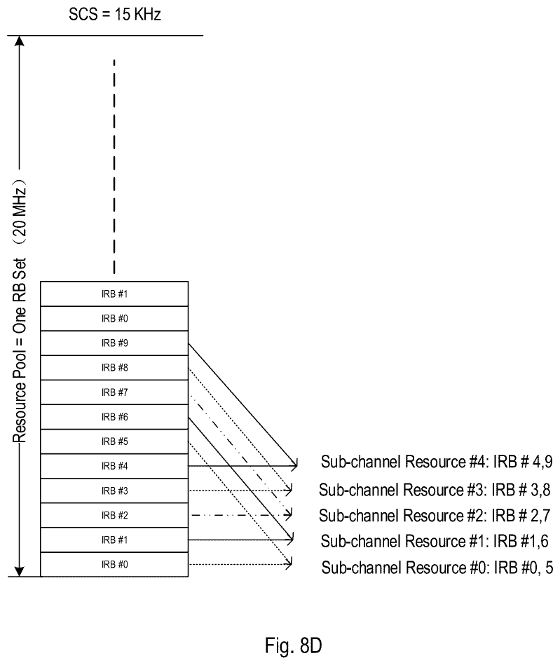

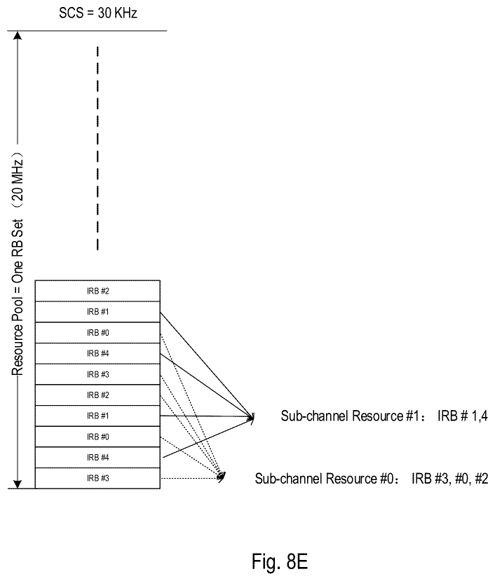

FIG. 8A illustrates an example of sub-channel resources in accordance with some embodiments of the present disclosure. In the example of FIG. 8A, k=1, an index of a sub-channel resource is identical to an index of a respective interlace. Within a resource pool 810, the index of the lowest sub-channel resource (i.e., the starting sub-channel resource) is 3 because the index of the respective interlace is 3.

In embodiments where the first number is equal to one, an index of a sub-channel resource may be different from an index of a respective IRB. In other words, there may be an offset between the index of the sub-channel resource and the index of the respective IRB. In embodiments where the first sub-channel resource comprises RBs in the first interlace, the index of the first interlace may be determined based on at least one of the following: an index of the first sub-channel resource, a first index of the lowest interlace with a sidelink resource pool or a sidelink BWP, or the number of interlaces.

In such embodiments, the index of the first interlace may be determined by performing a modulo operation of the number of interlaces on a sum of the index of the first sub-channel resource and the first index. For example, sub-channel resource #t may contain IRB #m, where m=(t+offset) mod M, 0≤t<M, M represents the number of IRB, the offset represents the index of the lowest IRB within an SL resource pool or an SL BWP.

FIG. 8B illustrates an example of sub-channel resources in accordance with some embodiments of the present disclosure. In the example of FIG. 8B, k=1, an index of a sub-channel resource is different from an index of a respective interlace. Within a resource pool 820, the lowest IRB index=3, i.e., offset=3, M=5. According to m=(t+offset) mod M, it may be determined that sub-channel resource #0 is mapping to IRB #3, sub-channel resource #1 is mapping to IRB #4, and so on.

FIG. 8C illustrates an example of sub-channel resources in accordance with some embodiments of the present disclosure. In the example of FIG. 8C, k=1, an index of a sub-channel resource is different from an index of a respective interlace. Within an SL BWP 830, the lowest IRB index=2, i.e., offset=2, M=5. According to m=(t+offset) mod M, it may be determined that sub-channel resource #0 contains IRB #2, sub-channel resource #1 contains IRB #3, and so on.

In addition, in the example of FIG. 8C, a starting sub-channel resource of a resource pool #1 is sub-channel resource #0, and a starting sub-channel resource of a resource pool #2 is not sub-channel resource #0.

As mentioned above, in embodiments where the first number is larger than one, each of the sub-channel resources may comprise RBs in the first number of interlaces with consecutive interlace indexes. In such embodiments, an index of a starting interlace among the first number of interlaces with the consecutive interlace indexes may be determined as a first index of the lowest interlace within a sidelink resource pool or a sidelink BWP. For example, if m represents the index of the starting interlace, m=the first index.

Alternatively, the index of the starting interlace among the first number of interlaces with the consecutive interlace indexes may be determined as a sum of the first index and multiple of the first number. For example, if m represents the index of the starting interlace, m=the first index+k, or m=the first index+2k . . . and so on.

In such embodiments, an index of each of the sub-channel resources may be determined based on the index of the starting interlace among the first number of interlaces with the consecutive interlace indexes and the first number. The index of each of the sub-channel resources may be determined by rounding down the index of the starting interlace divided by the first number. By defining mapping relationship between an index of a sub-channel resource and a respective IRB, it implicitly assigns resource mapping between the sub-channel resource and the IRB.

In some embodiments, the terminal device 110 may determine a first sub-channel resource comprising a first plurality of interlaces and determine a second sub-channel resource comprising a second plurality of interlaces. The second plurality of interlaces being not overlapped with the first plurality of interlaces. In other words, IRBs contained in different sub-channel resources may be not overlapped.

In such embodiments, for k>1, sub-channel #t contains IRB #m, #m+1, . . . , #m+k−1, t=└m/k┘, where t represents an index of a sub-channel resource and 0≤t<M′, m represents the index of the starting interlace, k represents the first number, M′ represents the number of sub-channel resources and M′=└M/k┘ or ┌M/k┐, M represents the number of IRBs.

For example, for SCS of 15 kHz, IRB index=[0, 1, . . . , 9], k=2. According to sub-channel #t contains IRBs #m and #m+1, it may be determined that sub-channel resource #0 contains IRBs #0 and #1, sub-channel resource #1 contains IRBs #2 and #3, and so on.

For another example, for SCS of 30 kHz, IRB index=[0, 1, . . . , 4], k=2. According to sub-channel #t contains IRBs #m and #m+1, it may be determined that sub-channel resource #0 contains IRBs #0 and #1, sub-channel resource #1 contains IRBs #2 and #3, sub-channel resource #2 contains IRB #4, and so on.

In embodiments where the first number is larger than one and each of the sub-channel resources may comprise RBs in the first number of interlaces with consecutive interlace indexes, the index of the starting sub-channel resource may not be 0. In such embodiments, there may be an offset between the index of the sub-channel resource and the index of the respective IRB.

In such embodiments, an index of a starting interlace among the first number of interlaces with the consecutive interlace indexes may be determined based on at least one of the following: an index of a respective one of the sub-channel resources, the first number, a first index of the lowest interlace with a sidelink resource pool or a sidelink BWP, or the number of interlaces.

In such embodiments, the index of the starting interlace may be determined by performing a modulo operation of the number of interlaces on a sum of the first index and a product of the index of the respective one of sub-channel resources and the first number.

In such embodiments, for the case where k>1, sub-channel resource #t contains IRBs #m, #(m+1) mod M, . . . , # (m+k−1) mod M; where m=(t*k+offset) mod M, the offset represents the index of the lowest IRB within a sidelink resource pool or sidelink BWP, 0≤t<M′, M′ represents the number of sub-channel resources, M′=└M/k┘ or ┌M/k┐, M represents the number of IRBs. In such embodiments, IRBs contained in different sub-channel resources may not be overlapped.

For example, for SCS of 15 kHz, IRB indexes=[0, 1, . . . , 9], k=2. Within a resource pool, the index of the lowest IRB=3, i.e., the offset=3. According to sub-channel resource #t contains IRBs #m, #(m+1) mod M, it may be determined that sub-channel resource #0 contains IRBs #3 and #4; sub-channel resource #1 contains IRBs #5 and #6 and so on.

For another example, for SCS of 15 kHz, IRB indexes=[0, 1, . . . , 9], k=2. Within a sidelink BWP, the index of the lowest IRB=2, i.e., the offset=2. According to sub-channel resource #t contains IRBs #m, #(m+1) mod M, it may be determined that sub-channel resource #0 contains IRBs #2 and #3; sub-channel resource #1 contains IRBs #4 and #5 and so on.

In embodiments where the first number is larger than one and each of the sub-channel resources comprises RBs in the first number of interlaces with non-consecutive interlace indexes, an offset between indexes of any two adjacent interlaces among the interlaces with the non-consecutive interlace indexes may be determined based on at least one of the following:
an index of a respective one of the sub-channels,
the number of sub-channel resources within a sidelink resource pool or a sidelink BWP,
the number of interlaces, or
a first index of the lowest interlace within the sidelink resource pool or the sidelink BWP.

In some embodiments, indexes of the interlaces with the non-consecutive interlace indexes may be determined as: t, (t+M′) mod M, . . . , (t+(k−1)*M′) mod M. In other words, for k>1, sub-channel resource #t contains IRBs #t, #(t+M′) mod M, . . . , #(t+(k−1)*M′) mod M, where t represents the index of the respective one of sub-channel resources, M′ represents the number of the sub-channel resources within one of the following: an RB set, the sidelink resource pool or the sidelink BWP, M represents the number of interlaces, k represents the first number. This may provide discrete RB allocation for a sub-channel resource.

In such embodiments, the number of the sub-channel resources (represented by M′) within one of the following: a RB set, the sidelink resource pool or the sidelink BWP may be determined by rounding down the number of interlaces divided by the first number. Alternatively, the number of the sub-channel resources may be determined by rounding up the number of interlaces divided by the first number.

In such embodiments, IRBs contained in different sub-channel resources are not overlapped.

FIG. 8D illustrates an example of sub-channel resources in accordance with some embodiments of the present disclosure. In the example of FIG. 8D, within a sidelink resource pool, SCS=15 kHz, IRB index=[0, 1, . . . , 9] (i.e., M=10), k=2, and an index of the lowest IRB in the sidelink resource pool is 0. According to sub-channel resource #t contains IRBs #t, #(t+M′) mod M, . . . , #(t+(k−1)*M′) mod M (0≤t<M′), it may be determined that sub-channel resource #0 contains IRBs #0 and #5, sub-channel resource #1 contains IRBs #1 and #6, and sub-channel resource #2 contains IRBs #2 and #7, and so on.

Alternatively, in embodiments where the first number is larger than one and each of the sub-channel resources comprises RBs in the first number of interlaces with non-consecutive interlace indexes, indexes of the interlaces with the non-consecutive interlace indexes may be determined as: t+offset, (t+offset+M′) mod M, . . . , (t+offset+(k−1)*M′) mod M. In other words, for k>1, sub-channel resource #t contains IRBs #t+offset, #(t+offset+M′) mod M, . . . , #(t+offset+(k−1)*M′) mod M, where t represents the index of the respective one of sub-channel resources, M′ represents the number of the sub-channel resources within one of the following: an RB set, the sidelink resource pool or the sidelink BWP, M represents the number of interlaces, the offset represents the first index, k represents the first number. This may provide discrete RB allocation for a sub-channel resource.

FIG. 8E illustrates an example of sub-channel resources in accordance with some embodiments of the present disclosure. In the example of FIG. 8E, within a sidelink resource pool, SCS=30 kHz, IRB index=[0, 1, . . . , 4], k=3, M′=┌M/k┐=2, offset=3. According to sub-channel resource #t contains IRBs #t+offset, #(t+offset+M′) mod M, . . . , #(t+offset+(k−1)*M′) mod M (0≤t<M′), it may be determined that sub-channel resource #0 contains IRBs #0, 2 and #3, sub-channel resource #1 contains IRBs #1 and #4, and so on.

In some embodiments, the sidelink resource configuration information may comprise at least one of the following:
the sidelink carrier configuration indicating that a first plurality of RB sets are contained in a sidelink carrier,
the sidelink carrier configuration indicating that a plurality of sidelink BWPs (BWPs) are contained in the sidelink carrier,
the sidelink BWP configuration indicating that a second plurality of RB sets are contained in a sidelink BWP,
the sidelink BWP configuration indicating that a plurality of sidelink resource pools are contained in the sidelink BWP, or
the sidelink resource pool configuration indicating that a third plurality of RB sets are contained in a sidelink resource pool.

In some embodiments, the terminal device 110 may determine the allocation of the sub-channel resources within one of the following: the first plurality of the RB sets contained in the sidelink carrier, the second plurality of the RB sets contained in the sidelink BWP, or the third plurality of the RB sets contained in the sidelink resource pool.

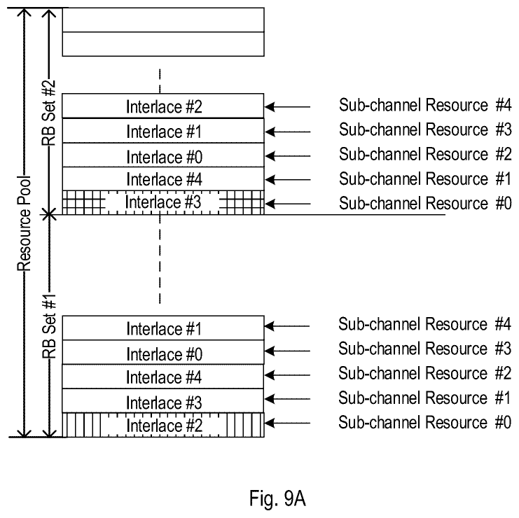

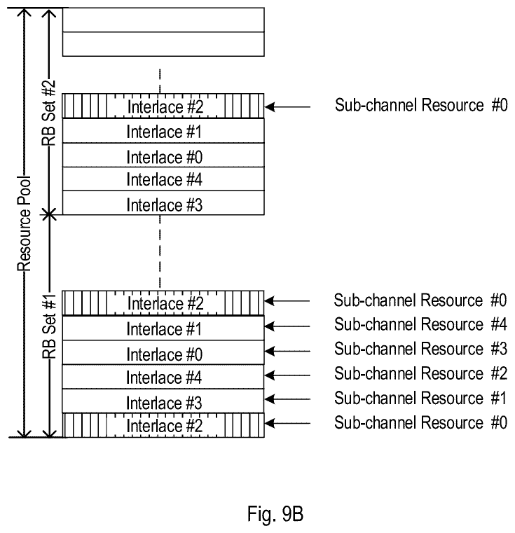

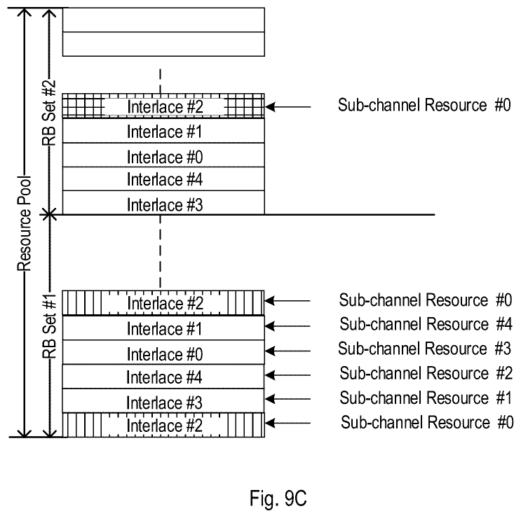

In such embodiments, the terminal device 110 may transmit an indication of the at least one of the sub-channel resources. The indication comprises an index of an RB set, and an index of a starting sub-channel resource among the at least one of the sub-channel resources. The index of the starting sub-channel resource may be determined within the RB set. In this way, the terminal device 110 may transmit a combined indication of sub-channel index and RB set index to assign PSSCH resource. This will be described with reference to FIG. 9A.

FIG. 9A illustrates an example of sub-channel resources in accordance with some embodiments of the present disclosure. In the example of FIG. 9A, RB set #1 and RB set #2 are contained within a sidelink resource pool. The terminal device 110 determines the allocation of the sub-channel resources for each of the RB set #1 and RB set #2. For example, for the RB set #1, the terminal device 110 determines sub-channel resource #0 contains interlace #2; for the RB set #2, the terminal device 110 determines sub-channel resource #0 contains interlace #3.

In addition, the terminal device 110 may transmit an indication comprising RB set #1 and sub-channel resource #0, and transmit sidelink signal on the indicated sub-channel. Upon receiving the indication, the terminal device 120 may receive sidelink signal on the assigned sub-channel resource #0 in RB set #1.

The terminal device 110 may also transmit an indication comprising RB set #2 and sub-channel resource #0, and transmit sidelink signal on the indicated sub-channel. Upon receiving the indication, the terminal device 130 may receive sidelink signal on the assigned sub-channel resource #0 in RB set #2.

In other embodiments, the terminal device 110 may determine the allocation of the sub-channel resources for one of the following: each of the sidelink resource pools, each of the sidelink BWPs, or the sidelink carrier. In such embodiments, the terminal device 110 may transmit an indication of the at least one of the sub-channel resources. The indication comprises an index of a starting sub-channel resource among the at least one of the sub-channel resources. The index of the starting sub-channel resource may be determined within the sidelink resource pool or within the sidelink BWP. This will be described with reference to FIG. 9B.

FIG. 9B illustrates an example of sub-channel resources in accordance with some embodiments of the present disclosure. In the example of FIG. 9B, RB set #1 and RB set #2 are contained within a sidelink resource pool. The terminal device 110 determines the allocation of the sub-channel resources for the sidelink resource pool. In other words, the terminal device 110 determines the allocation of the sub-channel resources for all of the RB set #1 and RB set #2. For example, for all of the RB set #1 and RB set #2, the terminal device 110 determines sub-channel resource #0 contains interlace #2 in all of the RB set #1 and RB set #2.

In addition, the terminal device 110 may transmit an indication comprising sub-channel resource #0, and transmit sidelink signal on the indicated sub-channel, i.e., interlace #2 in RB set #1 and RB set #2. Upon receiving the indication, the terminal device 120 may receive sidelink signal on sub-channel resource #0 in all of the RB set #1 and RB set #2. In other words, the terminal device 120 may receive all the resources of interlace #2 in the RB set #1 and RB set #2.

In embodiments where the terminal device 110 determines the allocation of the sub-channel resources for one of the following: each of the sidelink resource pools, each of the sidelink BWPs, or the sidelink carrier, the terminal device 110 may transmit a combined indication of the index of an RB set and the index of the starting sub-channel resource. The index of the starting sub-channel resource may be determined within the sidelink resource pool which comprises the RB set or within the sidelink BWP which comprises the RB set. This will provide more resource allocation flexibility. This will be described with reference to FIG. 9C.

FIG. 9C illustrates an example of sub-channel resources in accordance with some embodiments of the present disclosure. Similar to the example of FIG. 9B, in the example of FIG. 9C, RB set #1 and RB set #2 are contained within a sidelink resource pool, and the terminal device 110 determines the allocation of the sub-channel resources for the sidelink resource pool. For example, for all of the RB set #1 and RB set #2, the terminal device 110 determines sub-channel resource #0 contains interlace #2 in all of the RB set #1 and RB set #2.

Different from the example of FIG. 9B, in the example of FIG. 9C, the terminal device 110 may transmit an indication comprising RB set #1 and sub-channel resource #0, and transmit sidelink signal on the indicated sub-channel, i.e., interlace #2 in RB set #1. Upon receiving the indication, the terminal device 120 may receive sidelink signal on the sub-channel resource #0 in RB set #1. In other words, the terminal device 120 may receive signal on interlace #2 in RB set #1.

The terminal device 110 may also transmit an indication comprising RB set #2 and sub-channel resource #0, and transmit sidelink signal on the indicated sub-channel, i.e., interlace #2 in RB set #2. Upon receiving the indication, the terminal device 130 may receive sidelink signal on the sub-channel resource #0 in RB set #2. In other words, the terminal device 130 may receive signal on interlace #2 in RB set #2.

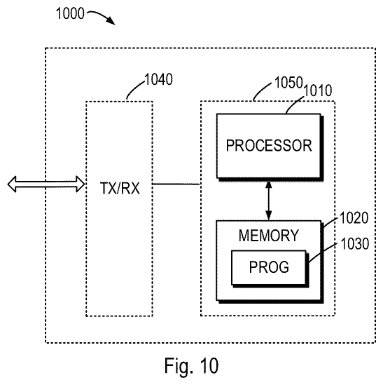

FIG. 10 is a simplified block diagram of a device 1000 that is suitable for implementing some embodiments of the present disclosure. The device 1000 can be considered as a further example embodiment of one of the terminal devices 110, 120 and 130 or the network device 140 or 150 as shown in FIG. 1. Accordingly, the device 1000 can be implemented at or as at least a part of one of the terminal devices 110, 120 and 130 or the network device 140 or 150.

As shown, the device 1000 includes a processor 1010, a memory 1020 coupled to the processor 1010, a suitable transmitter (TX) and receiver (RX) 1040 coupled to the processor 1010, and a communication interface coupled to the TX/RX 1040. The memory 1020 stores at least a part of a program 1030. The TX/RX 1040 is for bidirectional communications. The TX/RX 1040 has at least one antenna to facilitate communication, though in practice an Access Node mentioned in this application may have several ones. The communication interface may represent any interface that is necessary for communication with other network elements, such as X2 interface for bidirectional communications between gNBs or eNBs, S1 interface for communication between a Mobility Management Entity (MME)/Serving Gateway (S-GW) and the gNB or eNB, Un interface for communication between the gNB or eNB and a relay node (RN), or Uu interface for communication between the gNB or eNB and a terminal device.

The program 1030 is assumed to include program instructions that, when executed by the associated processor 1010, enable the device 1000 to operate in accordance with the embodiments of the present disclosure, as discussed herein with reference to FIGS. 1 to 10. The embodiments herein may be implemented by computer software executable by the processor 1010 of the device 1000, or by hardware, or by a combination of software and hardware. The processor 1010 may be configured to implement various embodiments of the present disclosure. Furthermore, a combination of the processor 1010 and memory 1020 may form processing means 1050 adapted to implement various embodiments of the present disclosure.

The memory 1020 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 1020 is shown in the device 1000, there may be several physically distinct memory modules in the device 1000. The processor 1010 may be of any type suitable to the local technical network, and may include one or more of general purpose computers, special purpose computers, microprocessors, digital signal processors (DSPs) and processors based on multicore processor architecture, as non-limiting examples. The device 1000 may have multiple processors, such as an application specific integrated circuit chip that is slaved in time to a clock which synchronizes the main processor.

The components included in the apparatuses and/or devices of the present disclosure may be implemented in various manners, including software, hardware, firmware, or any combination thereof. In one embodiment, one or more units may be implemented using software and/or firmware, for example, machine-executable instructions stored on the storage medium. In addition to or instead of machine-executable instructions, parts or all of the units in the apparatuses and/or devices may be implemented, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), and the like.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to any of FIGS. 1 to 10. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific embodiment details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

What is claimed is:

1. A method for communications, comprising:
determining, at a terminal device, an allocation of sub-channel resources based on sidelink resource configuration information, each of the sub-channel resources comprising a first number of interlaces in frequency domain; and
transmitting or receiving a sidelink signal on at least one of the sub-channel resources.

2. The method of claim 1, wherein the sidelink resource configuration information comprises at least one of the following:
an interlace enablement indication which indicates using interlace as frequency domain resource unit for sidelink transmission,
a sub-channel configuration,
a sidelink carrier configuration,
a sidelink bandwidth part configuration, or
a sidelink resource pool configuration.

3. The method of claim 2, further comprising:
obtaining the sidelink resource configuration information from at least one of following:
pre-definition,
configuration, or
pre-configuration.

4. The method of claim 2, wherein the sub-channel configuration is for at least one of the following:
a sidelink resource pool,
a sidelink BWP,
a sidelink carrier, or
a resource block set.

5. The method of claim 2, wherein the sub-channel configuration comprises:
a size of each of the sub-channel resources.

6. The method of claim 5, wherein the size of each of the sub-channel resources indicates the first number, wherein the first number is a positive integer.

7. The method of claim 5, wherein the size of each of the sub-channel resources indicates a second number of resource blocks (RBs) contained in each of the sub-channel resources.

8. The method of claim 7, wherein determining the allocation of sub-channel resources comprises:
determining the first number based on the second number and a third number, wherein the third number is the number of RBs in an interlace within one of the following:
an RB set, a sidelink resource pool, or a sidelink bandwidth part (BWP).

9. The method of claim 8, wherein determining the first number comprises:
determining the first number as the second number divided by the third number;
determining the first number by rounding down the second number divided by the third number; or
determining the first number by rounding up the second number divided by the third number.

10. The method of claim 1, wherein the first number is equal to one, and the sub-channel resources comprises a first sub-channel resource, the first sub-channel resource comprising resource blocks in a first interlace.

11. The method of claim 10, wherein an index of the first sub-channel resource is identical to an index of the first interlace.

12. The method of claim 10, wherein the index of the first interlace is determined based on at least one of the following:
an index of the first sub-channel resource,
a first index of the lowest interlace with a sidelink resource pool or a sidelink bandwidth part, or
the number of interlaces.

13. The method of claim 12, wherein the index of the first interlace is determined by performing a modulo operation of the number of interlaces on a sum of the index of the first sub-channel resource and the first index.

14. The method of claim 1, wherein the first number is larger than one, and each of the sub-channel resources comprises resource blocks in the first number of interlaces with consecutive interlace indexes.

15. The method of claim 14, wherein an index of a starting interlace among the first number of interlaces with consecutive interlace indexes is determined as at least one of the following:
a first index of the lowest interlace within a sidelink resource pool or a sidelink bandwidth part (BWP), or
a sum of the first index and multiple of the first number.

16. The method of claim 15, wherein an index of each of the sub-channel resources is determined based on the index of the starting interlace among the first number of interlaces with the consecutive interlace indexes and the first number.

17. The method of claim 16, wherein the index of each of the sub-channel resources is determined by rounding down the index of the starting interlace divided by the first number.

18. The method of claim 14, wherein an index of a starting interlace among the first number of interlaces with the consecutive interlace indexes is determined based on at least one of the following:
an index of a respective one of the sub-channel resources,
the first number,
a first index of the lowest interlace with a sidelink resource pool or a sidelink bandwidth part (BWP), or
the number of interlaces.

19. The method of claim 18, wherein the index of the starting interlace is determined by performing a modulo operation of the number of interlaces on a sum of the first index and a product of the index of the respective one of sub-channel resources and the first number.

20. The method of claim 1, wherein the first number is larger than one, and each of the sub-channel resources comprises resource blocks in the first number of interlaces with non-consecutive interlace indexes.

21. The method of claim 20, wherein an offset between indexes of any two adjacent interlaces among the interlaces with the non-consecutive interlace indexes is determined based on at least one of the following:
an index of a respective one of the sub-channels,
the number of sub-channel resources within a sidelink resource pool or a sidelink bandwidth part (BWP),
the number of interlaces, or
a first index of the lowest interlace within the sidelink resource pool or the sidelink BWP.

22. The method of claim 21, wherein indexes of the interlaces with the non-consecutive interlace indexes are determined as:
t, (t+M′) mod M, . . . , (t+(k−1)*M′) mod M;
where t represents the index of the respective one of sub-channel resources, M′ represents the number of the sub-channel resources within one of the following: a resource block set, the sidelink resource pool or the sidelink BWP, M represents the number of interlaces, k represents the first number.

23. The method of claim 21, wherein indexes of the interlaces with the non-consecutive interlace indexes are determined as:
t+offset, (t+offset+M′) mod M, . . . , (t+offset+(k−1)*M′) mod M;
where t represents the index of the respective one of sub-channel resources, M′ represents the number of the sub-channel resources within one of the following: a resource block set, the sidelink resource pool or the sidelink BWP, M represents the number of interlaces, the offset represents the first index, k represents the first number.

24. The method of claim 22 or 23, wherein the number of the sub-channel resources within one of the following: a resource block set, the sidelink resource pool or the sidelink BWP is determined by:
rounding down the number of interlaces divided by the first number; or
rounding up the number of interlaces divided by the first number.

25. The method of claim 1, wherein determining the allocation of sub-channel resources comprises:
determining a first sub-channel resource comprising a first plurality of interlaces; and
determining a second sub-channel resource comprising a second plurality of interlaces, the second plurality of interlaces being not overlapped with the first plurality of interlaces.

26. The method of claim 2, wherein the sidelink resource configuration information comprises at least one of the following:
the sidelink carrier configuration indicating that a first plurality of resource block (RB) sets are contained in a sidelink carrier,
the sidelink carrier configuration indicating that a plurality of sidelink bandwidth parts (BWPs) are contained in the sidelink carrier,
the sidelink BWP configuration indicating that a second plurality of RB sets are contained in a sidelink BWP,
the sidelink BWP configuration indicating that a plurality of sidelink resource pools are contained in the sidelink BWP, or
the sidelink resource pool configuration indicating that a third plurality of RB sets are contained in a sidelink resource pool.

27. The method of claim 26, wherein determining the allocation of sub-channel resources comprises:
determining the allocation of the sub-channel resources for one of the following:
each of the first plurality of RB sets, the second plurality of RB sets, and the third plurality of RB sets,
each of the sidelink resource pools,
each of the sidelink BWPs, or
the sidelink carrier.

28. The method of claim 26, wherein determining the allocation of the sub-channel resources comprises:
determining the allocation of the sub-channel resources within one of the following:
the first plurality of the RB sets contained in the sidelink carrier,
the second plurality of the RB sets contained in the sidelink BWP, or
the third plurality of the RB sets contained in the sidelink resource pool.

29. The method of claim 1, further comprising:
transmitting an indication of the at least one of the sub-channel resources, the indication comprising:
an index of a resource block (RB) set, and
an index of a starting sub-channel resource among the at least one of the sub-channel resources.

30. The method of claim 29, wherein the index of the starting sub-channel resource is determined within one of the following:
the RB set,
a sidelink resource pool which comprises the RB set, or
a sidelink bandwidth part which comprises the RB set.

31. The method of claim 1, further comprising:
transmitting an indication of the at least one of the sub-channel resources, the indication comprising an index of a starting sub-channel resource among the at least one of the sub-channel resources.

32. The method of claim 31, wherein the index of the starting sub-channel resource is determined within one of the following:
a resource block (RB) set,
a sidelink resource pool, or
a sidelink bandwidth part.

33. A terminal device, comprising:
a processor; and
a memory coupled to the processor and storing instructions thereon, the instructions, when executed by the processor, causing the terminal device to perform the method according to any of claims 1-32.

34. A computer readable medium having instructions stored thereon, the instructions, when executed on at least one processor of a device, causing the device to carry out the method according to any of claims 1-32.
